(19) United States
(12) Patent Application Publication
(10) Pub. No.: US 2008/0236449 A1
(43) Pub. Date: Oct. 2, 2008

(54) NOVEL DUAL-CURABLE WATER-BORNE URETHANE DISPERSIONS

(75) Inventors: Shi Yang, Cary, NC (US); Glenn Petschke, Raleigh, NC (US); Kristy Magyar, Cary, NC (US)

Correspondence Address: MYERS BIGEL SIBLEY & SAJOVEC, PO BOX 37428, RALEIGH, NC, 27627, US

(73) Assignee: Reichhold, Inc.

(21) Appl. No.: 11/692,398

(22) Filed: Mar. 28, 2007

(51) Int. Cl. C08G 71/04

(52) U.S. Cl. 106/287.11; 528/12

(57) ABSTRACT

Provided herein according to some embodiments of the present invention are dual-crosslinkable waterborne urethane coating compositions including an ionically-charged urethane having oxidative curable ethylenic unsaturation and self condensing silanol functionality.

### FIELD OF THE INVENTION

This invention relates to silane-modified urethane polymers, and in particular, to silane-modified water-borne urethane polymers containing ethylenic unsaturation.

### BACKGROUND OF THE INVENTION

It is well known to those in the coating industry that polyurethane coatings may be relatively durable and may exhibit desirable flexibility and resistance to abrasion, chemicals and solvents. In fact, the durability of polyurethane coatings has led to their use in light industrial maintenance and the highly demanding wood floor finishing markets for many years. Typical categories of polyurethane coatings include oil modified, moisture curing, two component and thermoplastic polymers. The oil modified, moisture curing and two component types may be desirable due to their ability to be field applied and to crosslink under ambient conditions. However, both the moisture curing and two component types may not be desirable for “do-it-yourself” application due to the exposure concern with respect to isocyanate-functional components. Accurate weighing and mixing of the two components immediately prior to application further reduces its desirability in this market. In addition, due to government regulatory pressure to reduce the volatile organic content (VOC) of these coatings, water-borne products have been gaining favor.

Many water-borne polyurethanes may be synthesized by first reacting a diol and a dihydroxy carboxylic acid with an excess of diisocyanate to produce an isocyanate-terminated prepolymer. The acid groups of this prepolymer may then be neutralized with volatile tertiary amines to form an anionic salt group and the neutralized isocyanate terminated prepolymer then dispersed into water. Other means of preparing water dispersible polyurethanes include incorporating a tertiary amine group into the polymer backbone and neutralizing with an acid, such as acetic acid, to form a cationic polyurethane, or by incorporating a hydrophilic group onto the polymer backbone, such as methoxy polyethylene glycol, to form a non-ionic polyurethane. The molecular weight of the water dispersed prepolymer may also be increased substantially by the addition of a polyamine. These polymers are typically linear since highly crosslinked polymers may form insoluble gels.

The majority of water-borne urethane coatings are anionic, with their film performance typically related to the monomer composition, molecular weight and chain interaction. To increase the chemical resistance and improve the durability of these water-borne coatings, crosslinking agents such as polyaziridines, carbodiimides and epoxy-silanes may be added immediately prior to application. Variants of these water-borne polyurethanes can be also made wherein a second component water-dispersible polyisocyanates is added to form highly crosslinked coatings. As discussed above, these two component systems typically demand accurate weighing and mixing just prior to application and user contact with water-dispersible polyisocyanate or polyaziridine crosslinkers may create health concerns. Furthermore, the carbodiimide and epoxy silane systems may benefit from the application of heat to facilitate crosslinking. For these reasons, one component systems have been generally preferred in the “do-it-yourself” finishing market.

U.S. Pat. No. 4,147,679 proposes the introduction of pendent ethylenic unsaturation into a water-borne urethane polymer such that self-crosslinking of the polymer by air oxidiation is possible. This oxidative crosslinking can take from hours to days to reach full cure of the coating. While significant improvements in film performance may be achieved with these coatings, particularly mar resistance, the amount of pendent ethylenic unsaturation is limited by the viscosity of the dispersion and their color, both varnish and film, may be related to the level of unsaturation.

U.S. Pat. Nos. 4,582,873 and 5,681,622 describe a process for the production of aqueous dispersions of internally silylated polyurethane resins. These resins have found utility as adhesion promoters, particularly for glass and metal substrates where previously blends of polyurethane dispersions and organosilane coupling agents were used. However, the randomness of the blends, particularly at the surface interface may reduce their effectiveness. In addition, these silylated polyurethane resins may not contain sufficient crosslinking capability to provide all of the performance requirements of light industrial maintenance or wood floor coatings.

### SUMMARY OF THE INVENTION

Provided herein according to some embodiments of the present invention are dual-crosslinkable waterborne urethane coating compositions including an ionically-charged urethane having an oxidative curable ethylenic unsaturated portion and at least one curable silanol functional group.

The dual-crosslinkable water-borne urethanes may be synthesized by various suitable methods known to those skilled in the art. According to some embodiments of the invention, methods of forming dual-crosslinkable water-borne urethanes may include:
(a) preparing a prepolymer by reacting a polyisocyanate with
   (i) a compound including two or more active hydrogens;
   (ii) a hydroxyl functional monomer containing ethylenic unsaturation; and
   (iii) a monomer including at least one carboxylic acid group and two or more hydroxyl functional groups;
(b) neutralizing the acid functional groups of the prepolymer;
(c) dispersing the prepolymer into an aqueous solution; and
(d) chain extending or terminating the neutralized prepolymer by addition of amine functional monomer(s), a portion of which is an amino-silane monomer wherein the silane group hydrolyzes to a silanol group.

According to other embodiments of the present invention, methods of forming dual-crosslinkable water-borne urethanes may include
(a) preparing a prepolymer by reacting a polyisocyanate with
   (i) a compound including two or more active hydrogens;
   (ii) a hydroxy functional monomer containing an ethylenic unsaturation;
   (iii) a monomer including at least one carboxylic acid group and two or more hydroxy functional groups;
(b) blending the prepolymer with an organosilane monomer containing one or more isocyanato functional groups;
(c) neutralizing the acid functional groups of the prepolymer;
(d) dispersing the prepolymer and isocyanate functional organosilane monomer blend into an aqueous solution wherein the silane groups hydrolyze to form silanol groups; and
(e) chain extending the neutralized prepolymer and isocyanate functional organosilane monomer dispersion by adding a polyamine to produce the dual-crosslinkable water-borne polyurethane.

According to some embodiments of the present invention, the oxidative curable ethylenic unsaturated portion of the urethane may contain an oxidative curable ethylenic unsaturation from a drying or semi-drying oil or an unsaturated fatty acid.

In some embodiments of the invention, the dual-crosslinkable water-borne urethane may contain both anionic and hydrophilic nonionic groups by introduction of compounds such as polyethylene glycol mono methyl ether during the prepolymer formation stage.

Also provided according to some embodiments of the invention are methods for coating a substrate that include coating a substrate with a composition including a dual-crosslinkable urethane coating according to an embodiment of the invention.

### DETAILED DESCRIPTION OF EMBODIMENTS OF THE INVENTION

The invention is described more fully hereinafter. This invention may, however, be embodied in many different forms and should not be construed as limited to the embodiments set forth herein. Rather, these embodiments are provided so that this disclosure will be thorough and complete, and will fully convey the scope of the invention to those skilled in the art.

The terminology used herein is for the purpose of describing particular embodiments only and is not intended to be limiting of the invention. As used herein, the singular forms “a”, “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

The methods of the present invention include first preparing a prepolymer by reacting a polyisocyanate with a compound including two or more active hydrogens, a hydroxy functional monomer containing an ethylenic unsaturation, and a monomer including at least one carboxylic acid group and two or more hydroxy functional groups. In one embodiment the acid functional groups of the prepolymer are neutralized, the polymer dispersed in an aqueous solution and chain extension or termination of the neutralized prepolymer occurs by addition of amine functional monomer(s), a portion of which is an amino-silane monomer wherein the silane group hydrolyzes to a silanol group.

In another embodiment, the prepolymer is blended with an organosilane monomer containing one or more isocyanate functional groups. The acid functional group of the prepolymer are then neutralized. The prepolymer and organosilane monomer having isocyanate functional groups is dispersed in an aqueous solution wherein the silane groups are hydrolyzed to form silanol groups. The dispersion is then chain extended by adding a polyamine.

In other embodiments, at least one curable silane-functional group may be incorporated into the urethane through a reaction of an epoxy-silane with a carboxylic acid group in the urethane prepolymer.

The incorporation of silyl crosslinking into a water-borne urethane polymer containing ethylenic unsaturation provides a coating resin that may crosslink in a two-stage process. In an initial stage, volatiles may evaporate from the film and the silanol groups condense, e.g., to form siloxane bonds (Si —O—Si), interact with the substrate to form organosilane bonds (Si —O—C) or a combination of both. Substrates that may interact with the silanol groups include wood fiber and textiles (e.g., via hydroxyl groups) or inorganic substrates, such as concrete and metal (e.g., via carboxyl groups). Ultimately, the second stage crosslinking by oxidation, e.g., by air oxidation, of the ethylenic unsaturation, may result in a highly durable coating having improved adhesion due to the silyl crosslinking of the resin with the substrate.

Thus, according to some embodiments of the present invention, dual-crosslinkable water-borne urethane coating compositions may include an ionically-charged urethane having an oxidative curable ethylenic unsaturated portion and at least one silanol functional group. In some embodiments of the invention, the urethane may be anionically charged, e.g., the urethane may include a carboxylate group. However, in some embodiments, the urethane may also contain a nonionic hydrophilic group, e.g. poly(ethylene oxide).

In some embodiments of the present invention, the oxidative curable ethylenic unsaturated portion of the urethane may include an oxidative curable ethylenic unsaturation from a drying or semi-drying oil or an unsaturated fatty acid. The term “drying or semi-dry oil” refers to an oil with one or more sites of ethylenic unsaturation. Any suitable drying or semi-drying oil may be used. However, exemplary oils include, but are not limited to, fish oil, coffee oil, soy bean oil, safflower oil, tung oil, tall oil, calendula, rapeseed oil, peanut oil, linseed oil, sesame oil, olive oil, dehydrated castor oil, tallow oil, sunflower oil, corn oil, peanut oil, canola oil, and mixtures thereof.

The term “unsaturated fatty acid” refers to a carboxylic acid often with an aliphatic tail having a number of carbon atoms in a range of 8 and 30, in some embodiments, in a range of 12 and 24, and in some embodiments, in a range of 16 to 20. Alkyl fatty esters, such as methyl, ethyl, propyl, butyl, amyl, and cyclohexyl esters, and the like, may also be included. Exemplary unsaturated fatty acids include oleic, linoleic acids, linolenic, palmitoleic acids, erucic, linolenic acids, eleostearic acids, arachidonic acids, ricinoleic acids, and mixtures thereof. In some embodiments, at least a portion of the oxidative curable monomer may be a polyacid including one or more of isophthalic acid, terephthalic acid, 5-(sodiosulfo)-isophthalic acid, trimellitic anhydride, adipic acid, 1,4-cyclohexyl dicarboxylic acid, succinic anhydride, maleic acid, fumaric acid, succinic acid, azaleic acid, sebacic acid, methyl succinic anhydride, dodecenyl succinic anhydride, tetrahydrophthalic anhydride, hexahydrophthalic anhydride, phthalic anhydride and mixtures thereof.

In some embodiments of the present invention, at least one curable silane-functional group is terminal or pendent to the main urethane polymer chain. In some embodiments, at least one curable silane-functional group may be incorporated into the urethane through a reaction of an amino-silane with an isocyanate-terminated urethane prepolymer. In some embodiments, at least one curable silane-functional group may be incorporated into the urethane through reaction of an isocyanate-silane monomer by addition during the prepolymer preparation or by blending the previously prepared prepolymer with the isocyanate-silane monomer.

The term “polyisocyanate” refers to a compound including two or more isocyanate groups. Any suitable polyisocyanate may be used, but exemplary polyisocyanates include 1,4-tetramethylene diisocyanate, 1,6-hexamethylene diisocyanate, 2,2,4-trimethyl-1,6-diisocyanatohexane, 1,10-decamethylene diisocyanate, 1,4-cyclohexane diisocyanate, bis (4-isocyanatocyclohexyl)methane, 1-isocyanato-3-isocyanatomethyl-3,5,5,-trimethylcyclohexane, m- and p-phenylene diisocyanate, 2,6- and 2,4-tolylene diisocyanate, xylene diisocyanate, 4-chloro-1,3-phenylene diisocyanate, 4,4′-bisphenylene diisocyanate, 4,4′-methylene diphenylisocyante, 1,5-naphthylene diisocyanate, 1,5-tetrahydronaphthylene diisocyanate, 1,12-dodecyldiisocyanate, norbornyl diisocyanate, 2-methyl-1,5-pentane diisocyanate, m-tetramethylxylene diisocyanate, 1,6-hexamethylene diisocyanate homopolymers, isocyanurate of isophorone diisocyanate and mixtures thereof.

The term “a compound including two or more active hydrogens” refers to a compound having two or more hydrogen atoms available for chemical interaction (i.e., hydrogen donors). Any suitable compound with two or more active hydrogens may used to form the prepolymer. Exemplary compounds with two or more active hydrogens include polyfunctional alcohols such as ethylene glycol, propylene glycol, 1,3 propane diol, 1,3 butylene diol, hydrogenated bisphenol-A, trimethylolpropane, trimethylol-ethane, pentaerythritol, glycerin, neopentyl glycol, cyclohexane dimethanol, 2-methyl-1,3-propanediol, 1,6-hexanediol di-pentaerythritol, di-ethylene glycol, tri-ethylene glycol, di-trimethylolpropane. Other compounds having two or more active hydrogens may include glycols, such as polyethers, polyesters and polycarbonate and mixtures thereof.

Any suitable hydroxy functional monomer that includes ethylenic unsaturation may be used, but in some embodiments of the invention, the hydroxyl functional including ethylenic unsaturation may be formed by the esterification of a polyfunctional alcohol with an unsaturated fatty acid or a drying or semi-drying oil (described above). In some embodiments, the hydroxy functional monomer that includes ethylenic unsaturation has a hydroxyl value of in a range of about 50 to about 300. Furthermore, in some embodiments, the polyisocyanate may be reacted with the hydroxy functional monomer that includes ethylenic unsaturation in a ratio in a range of about 0.3 to about 3.0 NCO to OH.

The term “polyfunctional alcohol” refers to a compound having 2 or more hydroxyl functional groups as described above.

In addition, any suitable monomer containing at least one carboxylic acid group and two or more hydroxyl functional groups may be used. Exemplary monomers include dimethylol alkanoic acids, such as dimethylol propionic acid, dimethyl butanoic acid, and the like.

Suitable neutralizing agents include inorganic bases such as sodium hydroxide, potassium hydroxide, lithium hydroxide, ammonia and organic compounds such as tertiary amines including triethylamine dimethyl ethanol amine.

Suitable non-silane functional chain extending/terminating amines may include aliphatic, cycloaliphatic, aromatic and cycloaliphatic, heterocyclic amino alcohols, polyamines, hydrazine, substituted hydrazines, hydrazides, amides, water and mixtures thereof.

Suitable silane-functional chain extending/terminating amines can be selected from the group of amino propyl triethoxysilane aminopropyltrimethoxysilane, (aminoethyl)aminopropyl trimethoxysilane, N-aminoethyl-N-aminoethylaminopropyltrimethoxysilane, bis-(trimethoxysilypropyl)amine, aminoneohexyl trimethoxysilane, N-aminoethyl aminopropyl methyldimethoxysilane, amino neohexylmethyl dimethoxysilane, N-phenyl amino propyl trimethyloxysilane and mixtures thereof.

The organosilane monomer including one or more isocyanate groups refers to an organosilane compound containing both silane and isocyanate functional groups, e.g. gamma-isocyanato propyl triethoxy silane and gamma-isocyanato propyl trimethoxy silane.

Non-silane functional chain extending amines may include aliphatic, cycloaliphatic, aromatic and cycloaliphatic, heterocyclic amino alcohols, polyamines, hydrazine, substituted hydrazines, hydrazides, amides, water and mixtures thereof.

Also provided according to some embodiments of the invention are methods for coating a substrate that include coating a substrate with a composition including a dual-crosslinkable urethane coating according to an embodiment of the invention. The coating may be applied to any suitable substrate, but exemplary substrates include wood and textile substrates and inorganic substrates, such as concrete and metal, and the like. Such substrates typically inherently contain carboxyl or hydroxyl groups or both to interact with the silanol groups of the hydroxlyzed silane-functional groups.

Hereinafter, the present invention will be more specifically explained with reference to the following examples. However, these examples are given for the purpose of illustration and are not to be construed as limiting the scope of the invention.

### EXAMPLES

### Synthesis Intermediate

An ethylenic unsaturated polyol used in the preparation of Synthesis Example 2 and Synthesis Example 3 was prepared by reacting 216 g of pentaerythritol and 2500 g of soybean oil at 250° C. for 2 hours in the presence of 5.4 g of Calcium CemAll. The resulting hydroxy functional intermediate had a hydroxyl number of 128 and corresponding hydroxyl equivalent weight of 440.

### Comparative Example 1

A non-crosslinkable water-borne urethane resin was prepared by reacting 650 g of polytetramethyl ether glycol (MW=1000), 49.8 g dimethylol propionic acid, 119.2 g N-methylpyrrolidinone, 1.45 g diphenyl isodecyl phosphite, 1.45 g of Irganox 1076 and 247.4 g of isophorone diisocyanate at 90° C. for 3.1 hours (3.29% theoretical NCO content). The prepolymer was then cooled to about 75° C. and 37.6 g of triethylamine was added to neutralize the acid groups. After mixing for at least 15 minutes, 400 g of this neutralized prepolymer was transferred to 505 g of water at 16° C. over a 20 minute period. After mixing the dispersed prepolymer for about 15 minutes, a solution of 7.6 g of ethylene diamine and 89 g water was added over 5 minutes. The dispersion was then filtered (25 micron) and packaged. The wet properties are contained in Table I.

### Comparative Example 2

An air oxidative crosslinking water-borne urethane resin was prepared by reacting 270 g of the above describe intermediate, 60 g of polytetramethyl ether glycol (MW=1000), 27 g of dimethylol propionic acid, 90 g of N-methylpyrrolidinone and 170.3 g of isophorone diisocyanate at 85° C. for approximately 2.5 hours (2.71% theoretical NCO content). The prepolymer was then cooled to about 70° C. and 20.35 g of triethylamine was added to neutralize the acid groups. After mixing for at least 15 minutes, 550 g of this neutralized prepolymer was transferred to 695 g of water at 15° C. over a 15 minute period. After mixing the dispersed prepolymer for about 15 minutes, a solution of 7.72 g of ethylene diamine and 69 g water was added over 10 minutes. The dispersion was then heated for 1.0 hour at 35° C. and then filtered (50 microns) and packaged. The wet properties are contained in Table I.

### Example 1

A dual-crosslinkable water-borne urethane resin was prepared by reacting 270 g of the above describe intermediate, 60 g of polytetramethyl ether glycol (MW=1000), 27 g of dimethylol propionic acid, 90 g of N-methylpyrrolidinone and 170.3 g of isophorone diisocyanate at 85° C. for approximately 2.5 hours (2.71% theoretical NCO content). The prepolymer was then cooled to about 70° C. and 20.35 g of triethylamine was added to neutralize the acid groups. After mixing for at least 15 minutes, 550 g of this neutralized prepolymer was transferred to 718 g of water at 15° C. over a 15 minute period. After mixing the dispersed prepolymer for about 15 minutes, a solution of 14.31 g of amino ethyl amino propyl trimethoxy silane (GE Advanced Materials Silquest A-1120), 3.86 g of ethylene diamine and 100 g water was added over 10 minutes. The dispersion was then heated for 1.0 hour at 35° C. then filtered (50 micron) and packaged. The wet properties are contained in Table I.

TABLE I

| | Comparative | Comparative | |
|---|---|---|---|
| | Example 1 | Example 2 | Example 1 |
| Crosslinking | None | Air Oxidation | Dual⁽¹⁾ |
| Resin Wet Properties | | | |
| Solids, % | 36.0 | 34.0 | 34.9 |
| Acid # | 8.23 | 8.59 | 7.40 |
| Amine # | 8.17 | 7.64 | 7.47 |
| pH | 8.19 | 8.03 | 7.54 |
| Viscosity @25° C. | | | |
| cps⁽²⁾ | 88 | 328 | 198 |
| Stokes | 0.85 | 3.40 | 2.25 |
| G-H letter | C | N | I |
| Particle Size, nm | | | |
| Mn | 23 | 42 | 60 |
| Mv | 27 | 72 | 106 |
| Particle Distribution | 1.21 | 1.72 | 1.76 |
| Density, #/gal | 8.543 | 8.502 | 8.532 |

⁽¹⁾Air oxidation and silane
⁽²⁾Brookfield RVT-C/P, Cone #40

### Performance Testing

Coatings were prepared from the three polyurethane dispersions (Comparative Examples 1 and 2, and Example 1) using the formulae listed in the Table II.

TABLE II

| | Comparative | Comparative | |
|---|---|---|---|
| | Example 1 | Example 2 | Example 1 |
| Crosslinking | None | Air Oxidation | Dual⁽¹⁾ |
| Polyurethane | 200.00 | 200.00 | 200.00 |
| Mn (9%) Hydrocure III⁽²⁾ | 0.00 | 0.35 | 0.35 |
| Water | 0.00 | 28.30 | 24.00 |
| Byk 345⁽³⁾ | 0.00 | 0.35 | 0.35 |

⁽¹⁾Air oxidation and silane;
⁽²⁾OM Group;
⁽³⁾Byk Chemie

The coatings were allowed to age for 7 days and then films of each coating were drawn down on Bonderite 1000 with a 3 mil Byrd applicator. The films were allowed to cure for 7 days at 25 C and 50% Relative Humidity prior to testing.

The film performance data contained in Table III and Table IV illustrate the benefit of crosslinked over non-crosslinked films, as significant improvements in hardness, chemical resistance and solvent resistance may be achieved. The dual-crosslinking varnish may also harden more rapidly since this crosslinking occurs once the water evaporates from the film.

TABLE III

| | Comparative | Comparative | |
|---|---|---|---|
| | Example 1 | Example 2 | Example 1 |
| Crosslinking | None | Air Oxidation | Dual⁽¹⁾ |
| Film Performance⁽²⁾ | | | |
| Dry Time, hrs:min | | | |
| Set | 0:15 | 0:20 | 0:15 |
| Thru | 0:30 | 1:15 | 0:40 |
| Hard | 0:55 | 2:15 | 1:15 |
| Tackfree (200 g) hrs:min | 2:30 | 3:40 | 3:40 |
| Tackfree (500 g) hrs:min | 3:00 | 3:45 | 3:40 |
| Sward Hardness | | | |
| 1 day | — | 10 | 14 |
| 3 days | 18 | — | — |
| 7 days | 20 | 18 | 18 |
| Konig Hardness | 24 | 37 | 40 |
| Pencil Hardness | HB | HB | HB |
| Impact Resistance, in-lbs | | | |
| Direct/Reverse | 160/160 | 160/160 | 160/160 |
| Mandrel Bend, 1/8″ | Pass | Pass | Pass |
| Taber Abrasion, mg loss⁽³⁾ | 9 | 125 | 136 |

⁽¹⁾Air oxidation and silane
⁽²⁾3 mil wet film
⁽³⁾CS-17 wheels, 1 Kg load, 1000 cycles

TABLE IV

| | Comparative | Comparative | |
|---|---|---|---|
| | Example 1 | Example 2 | Example 1 |
| Crosslinking | None | Air Oxidation | Dual⁽¹⁾ |
| Film Performance⁽²⁾ | | | |
| Chemical Resistance, | 2.52 | 3.13 | 3.26 |
| average⁽³⁾ | | | |
| Acetic acid, 10% | 2 | 5 | 5 |
| Ammonia, Parson's | 1 | 3 | 4 |
| Ball Point Ink | 2 | 2 | 2 |
| Black Marker | 1 | 1 | 1 |
| Cleaner 409 | 2 | 2 | 3 |
| Coffee | 4 | 5 | 5 |
| Dye | 1 | 1 | 1 |
| Ethanol, 50% | 5 | 5 | 5 |
| Iodine | 2 | 1 | 1 |
| Ketchup | 5 | 5 | 5 |
| Lipstick | 2 | 4 | 4 |
| Merthiolate | 1 | 3 | 2 |
| Mustard | 3 | 3 | 3 |
| Nail Polish | 1 | 1 | 1 |
| Nitric acid, 2% | 3 | 4 | 5 |
| Polish Remover | 4 | 5 | 5 |
| Shoe Polish | 1 | 1 | 1 |
| Sodium hydroxide, 10% | 0 | 0 | 0 |
| Sulfuric acid, 10% | 5 | 5 | 5 |
| Sunblock, SPF-30 | 2 | 2 | 2 |
| Tea | 5 | 5 | 5 |
| Water | 5 | 5 | 5 |
| Windex Cleaner | 1 | 4 | 5 |
| Solvent Rubs, dbl | | | |
| Xylene | >200 | >200 | >200 |
| Isopropanol | 130 | >200 | >200 |
| Methyl ethyl ketone | 120 | 170 | >200 |

⁽¹⁾Air oxidation and silane;
⁽²⁾2 mil wet film;
⁽³⁾4 hr exposure, covered, rating 0–5 no effect

What is claimed is:

1. A dual-crosslinkable water-borne urethane coating composition comprising:
an ionically-charged urethane having an oxidative curable ethylenic unsaturated portion and at least one curable silane-functional group.

2. The dual-crosslinkable water-borne urethane coating composition of claim 1, wherein the ionically-charged urethane is anionically-charged.

3. The dual-crosslinkable water-borne urethane coating composition of claim 2, wherein the anionically-charged urethane comprises a carboxylate anion.

4. The dual-crosslinkable water-borne urethane coating composition of claim 1, wherein the ionically charged urethane is cationically-charged.

5. The dual-crosslinkable water-borne urethane coating composition of claim 1, wherein the ionically charged urethane contains a non-ionic hydrophilic group.

6. The dual-crosslinkable urethane coating composition of claim 1, wherein the oxidative curable ethylenic unsaturated portion of the urethane comprises an oxidative curable ethylenic unsaturation from a dry or semi-dry oil or an unsaturated fatty acid.

7. The dual-crosslinkable urethane coating composition of claim 1, wherein at least one curable silane-functional group comprises a terminal or pendent silane group.

8. The dual-crosslinkable urethane coating composition of claim 1, wherein at least one curable silane-functional group is incorporated into the urethane through a reaction of an amino-silane with an isocyanate-terminated urethane prepolymer.

9. The dual-crosslinkable urethane coating composition of claim 1, wherein at least one curable silane-functional group is incorporated into the urethane through a reaction of an isocyanate-functional silane with hydroxyl groups during the urethane prepolymer formation or with amine groups during prepolymer chain extension.

10. The dual-crosslinkable urethane coating composition of claim 1, wherein at least one curable silane-functional group is incorporated into the urethane through a reaction of an epoxy-silane with a carboxylic acid group in a urethane prepolymer.

11. A method for coating a surface of a substrate, comprising coating a surface with a composition comprising a dual-crosslinkable urethane coating composition according to claim 1, wherein the silane-functional groups are hydrolyzed to form silanol groups.

12. A method of forming a dual-crosslinkable water-borne urethane, comprising:
(a) preparing a prepolymer by reacting a polyisocyanate with
(i) a compound comprising two or more active hydrogens;
(ii) a hydroxyl functional monomer comprising an ethylenic unsaturation; and
(iii) a monomer comprising at least one carboxylic acid group and two or more hydroxyl functional groups;
(b) neutralizing the acid functional groups of the prepolymer;
(c) dispersing the prepolymer into water; and
(d) chain extending or terminating the neutralized prepolymer by addition of amine functional monomer(s) a portion of which is an amino-silane monomer wherein the silane group hydrolyzes to a silanol group.
to form a dual-crosslinkable water-borne polyurethane.

13. The method of claim 12, wherein the polyisocyanate comprises a polyisocyanate selected from the group consisting of 1,4-tetramethylene diisocyanate, 1,6-hexamethylene diisocyanate, 2,2,4-trimethyl-1,6-diisocyanatohexane, 1,10-decamethylene diisocyanate, 1,4-cyclohexane diisocyanate, bis(4-isocyanatocyclohexyl)methane, 1-isocyanato-3-isocyanatomethyl-3,5,5,-trimethylcyclohexane, m- and p-phenylene diisocyanate, 2,6- and 2,4-tolylene diisocyanate, xylene diisocyanate, 4-chloro-1,3-phenylene diisocyanate, 4,4′-bisphenylene diisocyanate, 4,4′-methylene diphenylisocyante, 1,5-naphthylene diisocyanate, 1,5-tetrahydronaphthylene diisocyanate, 1,12-dodecyldiisocyanate, norbornyl diisocyanate, 2-methyl-1,5-pentane diisocyanate m-tetramethylxylene diisocyanate, 1,6-hexamethylene diisocyanate homopolymers, isocyanurate of isophorone diisocyanate and mixtures thereof.

14. The method of claim 12, wherein the hydroxyl functional monomer comprising an ethylenic unsaturation is formed by the esterification of a polyfunctional alcohol with an unsaturated fatty acid or the transesterification of a polyfunctional alcohol with an oil.

15. The method of claim 14, wherein the polyfunctional alcohol is selected from the group consisting of ethylene glycol, propylene glycol, 1,3 propane diol, 1,3 butylene diol, bisphenol-A, hydrogenated bisphenol-A, trimethylolpropane, trimethylol-ethane, pentaerythritol, glycerin, neopentyl glycol, cyclohexane dimethanol, 2-methyl-1,3-propanediol, 1,6-hexanediol di-pentaerythritol, di-ethylene glycol, tri-ethylene glycol, di-trimethylolpropane and mixtures thereof.

16. The method of claim 14, wherein the unsaturated fatty acid is selected from the group consisting of oleic, linoleic acids, palmitoleic acids, linolenic acids, eleostearic acids, arachidonic acids, ricinoleic acids, and mixtures thereof.

17. The method of claim 14, wherein at least a portion of the fatty acid comprises a polyacid selected from the group consisting of isophthalic acid, terephthalic acid, 5-(sodiosulfo)-isophthalic acid, trimellitic anhydride, adipic acid, 1,4-cyclohexyl dicarboxylic acid, succinic anhydride, maleic acid, fumaric acid, succinic acid, azaleic acid, sebacic acid, methyl succinic anhydride, dodecenyl succinic anhydride, tetrahydrophthalic anhydride, hexahydrophthalic anhydride, phthalic anhydride and mixtures thereof.

18. The method of claim 14, wherein the wherein the oil is selected from the group of fish oil, coffee oil, soy bean oil, safflower oil, tung oil, tall oil, calendula, rapeseed oil, peanut oil, linseed oil, sesame oil, olive oil, dehydrated castor oil, tallow oil, sunflower oil, corn oil, peanut oil, canola oil, and mixtures thereof.

19. The method of claim 12, wherein the hydroxyl functional monomer comprising an ethylenic unsaturation has a hydroxyl value in a range of about 50 and about 300

20. The method of claim 12, wherein the polyisocyanate is reacted with (i) a compound comprising two or more active hydrogen, (ii) a hydroxyl functional monomer comprising an ethylenic unsaturation and (iii) a monomer comprising at least one carboxylic acid group and two or more hydroxyl functional groups in a ratio of about 0.3 to about 3.0 NCO group to total OH groups

21. The method of claim 12 wherein the silane-functional chain extending or terminating amine is selected from the group of amino propyl triethoxysilane aminopropyltrimethoxysilane, (aminoethyl)aminopropyl trimethoxysilane, N-aminoethyl-N-aminoethylaminopropyltrimethoxysilane, bis-(trimethoxysilypropyl)amine, aminoneohexyl trimethoxysilane, N-aminoethyl aminopropyl methyldimethoxysilane, amino neohexylmethyl dimethoxysilane, N-phenyl amino propyl trimethyloxysilane and mixtures thereof.

22. The method of claim 12 wherein the non-silane functional chain extending/terminating amines is selected from the group of aliphatic, cycloaliphatic, aromatic and cycloaliphatic, heterocyclic amino alcohols, polyamines, hydrazine, substituted hydrazines, hydrazides, amides, water and mixtures thereof.

23. A method of forming a dual-crosslinkable water-borne urethane, comprising:
(a) preparing a prepolymer by reacting a polyisocyanate with
(i) a compound comprising two or more active hydrogens;
(ii) a hydroxyl functional monomer comprising an ethylenic unsaturation;
(iii) a monomer comprising at least one carboxylic acid group and two or more hydroxyl functional groups; and
(iv) an organosilane monomer comprising one or more isocyanate reactable groups;
(b) neutralizing the acid functional groups of the prepolymer;
(c) dispersing the prepolymer and isocyanate functional organosilane monomer into water; and
(d) chain extending the neutralized prepolymer and isocyanate functional organosilane monomer by adding a polyamine.

24. The method of claim 23 wherein the polyamine is a silane-functional polyamine.

25. The method of claim 23, wherein the polyisocyanate comprises a polyisocyanate selected from the group consisting of 1,4-tetramethylene diisocyanate, 1,6-hexamethylene diisocyanate, 2,2,4-trimethyl-1,6-diisocyanatohexane, 1,10-decamethylene diisocyanate, 1,4-cyclohexane diisocyanate, bis(4-isocyanatocyclohexyl)methane, 1-isocyanato-3-isocyanatomethyl-3,5,5,-trimethylcyclohexane, m- and p-phenylene diisocyanate, 2,6- and 2,4-tolylene diisocyanate, xylene diisocyanate, 4-chloro-1,3-phenylene diisocyanate, 4,4′-bisphenylene diisocyanate, 4,4′-methylene diphenylisocyante, 1,5-naphthylene diisocyanate, 1,5-tetrahydronaphthylene diisocyanate, 1,12-dodecyldiisocyanate, norbornyl diisocyanate, 2-methyl-1,5-pentane diisocyanate, m-tetramethylxylene diisocyanate, 1,6-hexamethylene diisocyanate homopolymers, isocyanurate of isophorone diisocyanate and mixtures thereof.

26. The method of claim 23, wherein the hydroxyl functional monomer comprising an ethylenic unsaturation is formed by the esterification of a polyfunctional alcohol with an unsaturated fatty acid or the transesterification of a polyfunctional alcohol with an oil.

27. The method of claim 26, wherein the polyfunctional alcohol is selected from the group consisting of ethylene glycol, propylene glycol, 1,3 propane diol, 1,3 butylene diol, bisphenol-A, hydrogenated bisphenol-A, trimethylolpropane, trimethylol-ethane, pentaerythritol, glycerin, neopentyl glycol, cyclohexane dimethanol, 2-methyl-1,3-propanediol, 1,6-hexanediol di-pentaerythritol, di-ethylene glycol, tri-ethylene glycol, di-trimethylolpropane and mixtures thereof.

28. The method of claim 26, wherein the unsaturated fatty acid is selected from the group consisting of oleic, linoleic acids, palmitoleic acids, linolenic acids, eleostearic acids, arachidonic acids, ricinoleic acids and mixtures thereof.

29. The method of claim 26, wherein at least a portion of the fatty acid comprises a polyacid selected from the group consisting of isophthalic acid, terephthalic acid, 5-(sodiosulfo)-isophthalic acid, trimellitic anhydride, adipic acid, 1,4-cyclohexyl dicarboxylic acid, succinic anhydride, maleic acid, fumaric acid, succinic acid, azaleic acid, sebacic acid, methyl succinic anhydride, dodecenyl succinic anhydride, tetrahydrophthalic anhydride, hexahydrophthalic anhydride, phthalic anhydride and mixtures thereof.

30. The method of claim 26, wherein the hydroxyl functional monomer comprising an ethylenic unsaturation is formed by the transesterification of a polyfunctional alcohol with an oil, wherein at least a portion of the oil is unsaturated.

31. The method of claim 26, wherein the oil is selected from the group of fish oil, coffee oil, soy bean oil, safflower oil, tung oil, tall oil, calendula, rapeseed oil, peanut oil, linseed oil, sesame oil, olive oil, dehydrated castor oil, tallow oil, sunflower oil, corn oil, peanut oil, canola oil, and mixtures thereof.

32. The method of claim 23, wherein the hydroxyl functional monomer comprising an ethylenic unsaturation has a hydroxyl value in a range of about 50 and about 300.

33. The method of claim 23, wherein the polyisocyanate is reacted with (i) a compound comprising two or more active hydrogen, (ii) a hydroxyl functional monomer comprising an ethylenic unsaturation and (iii) a monomer comprising at least one carboxylic acid group and two or more hydroxyl functional groups in a ratio of about 0.3 to about 3.0 NCO group to total OH groups.

34. The method of claim 23, wherein the organosilane monomer comprising one or more isocyanate reactable groups is selected from the group consisting of isocyanatopropyl triethoxy silane and isocyanatopropyl trimethoxy silane.

35. The method of claim 23 wherein the chain extending polyamine is selected from the group of aliphatic, cycloaliphatic, aromatic and cycloaliphatic, heterocyclic amino alcohols, polyamines, hydrazine, substituted hydrazines, hydrazides, amides, water and mixtures thereof.
